(19) United States
(12) Patent Application Publication
(10) Pub. No.: US 2010/0255167 A1
(43) Pub. Date: Oct. 7, 2010

(54) Method for Reducing Acrylamide in Food Products

(75) Inventors: Wilfred Marcellien Bourg, JR., Melissa, TX (US); Pravin Maganlal Desai, Carrollton, TX (US); Bradley Scott Shepard, Wylie, TX (US); Michael Grant Topor, Little Elm, TX (US); Gerald James Vogel, Plano, TX (US)

Correspondence Address: CARSTENS & CAHOON, LLP, 13760 NOEL ROAD, SUITE 900, DALLAS, TX, 75240, US

(73) Assignee: FRITO-LAY NORTH AMERICA, INC., Plano, TX (US)

(21) Appl. No.: 12/419,796

(22) Filed: Apr. 7, 2009

(51) Int. Cl. A23L 1/015

(52) U.S. Cl. 426/478

(57) ABSTRACT

Disclosed is a method for reducing the level of acrylamide in a thermally processed food. In one aspect, acrylamide is first formed in a thermally processed food or food ingredient and is subsequently removed from the food or food ingredeint. The acrylamide can be removed by polymerizing the acrylamide, dissolving the acrylamide, and/or causing vaporization of the acrylamide.

### BACKGROUND OF THE INVENTION

1. Technical Field

The present invention relates to an improved method for reducing acrylamide formation in thermally processed food products.

2. Description of Related Art

The chemical acrylamide has long been used in its polymer form in industrial applications for water treatment, enhanced oil recovery, papermaking, flocculants, thickeners, ore processing and permanent-press fabrics. Acrylamide precipitates as a white crystalline solid, is odorless, and is highly soluble in water (2155 g/L at 30° C.). Synonyms for acrylamide include 2-propenamide, ethylene carboxamide, acrylic acid amide, vinyl amide, and propenoic acid amide. Acrylamide has a molecular mass of 71.08, a melting point of 84.5° C., and a boiling point of 125° C. at 25 mmHg.

In recent times, a wide variety of foods have tested positive for the presence of acrylamide monomer. Acrylamide has especially been found primarily in carbohydrate food products that have been heated or processed at high temperatures. Examples of foods that have tested positive for acrylamide include coffee, cereals, cookies, potato chips, crackers, french-fried potatoes, breads and rolls, and fried breaded meats. In general, relatively low contents of acrylamide have been found in heated protein-rich foods, while relatively high contents of acrylamide have been found in carbohydrate-rich foods, compared to non-detectable levels in unheated and boiled foods.

It would be desirable to develop one or more methods of reducing the level of acrylamide in the end product of heated or thermally processed foods. Ideally, such a process should substantially reduce or eliminate the acrylamide in the end product without adversely affecting the quality and characteristics of the end product.

### SUMMARY OF THE INVENTION

In one embodiment, the present invention is directed towards a method for the reduction of acrylamide formation in thermally processed foods or food ingredients by first forming acrylamide in a food or food ingredient by heating said food or food ingredient above an acrylamide formation temperature thereby forming acrylamide and subsequently treating said food to remove the acrylamide from the food.

In one embodiment, the present invention is directed towards a method for the reduction of acrylamide formation in thermally processed foods by forming products from ingredients with less potential for forming acrylamide. In one embodiment the invention is directed towards removal of the germ from a food ingredient prior to thermally processing the degermed food ingredient. In one aspect, the germ is treated to form and then remove acrylamide and the treated germ is then admixed with the degermed food ingredient prior to thermally processing the admix.

Other aspects, embodiments and features of the invention will become apparent from the following detailed description of the invention when considered in conjunction with the accompanying drawings. The accompanying figures are schematic and are not intended to be drawn to scale. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a general flow chart depiction of a method for making a food product having a reduced level of acrylamide in accordance with one embodiment of the present invention;

FIG. 2 is a flow chart depicting various embodiments of the present invention; and

FIG. 3 is a flow chart depicting various alternative embodiments of the present invention.

### DETAILED DESCRIPTION

The prior art discloses many ways to reduce the level of acrylamide in food product by using various additives such as enzymes to react with acrylamide precursors and/or inhibit the reaction pathways that lead to the formation of acrylamide in a food product. The present invention, on the other hand, in one embodiment, is directed towards the reduction of acrylamide in a food product by first forming acrylamide in a food or food ingredient and then removing the formed acrylamide from the food or food ingredient. One embodiment is thereby directed towards treating food ingredients used to make a food product. First forming acrylamide in the food ingredients and then removing acrylamide from the treated food ingredients provides a method that can advantageously reduce the concentrations of acrylamide pre-cursors such as asparagine and/or reducing sugars in the food ingredients which in turn lowers the acrylamide level in the food made with the treated food ingredients. This is expected to happen because a reduction of the acrylamide pre-cursors in the food ingredients can reduce the acrylamide formation rate in the product made from treated ingredients.

It should be pointed out, however, that some acrylamide pre-cursors may not always decrease upon the formation of acrylamide. For example, during various experiments using different raw materials, it was observed that potatoes with relatively low reducing sugar content actually had an increase in reducing sugars during processing. This may occur as a result of starch converting into sugars. In one test, reducing sugars in the finished thermally processed food product were about the same level as those thermally processed food products produced from relatively higher reducing sugar raw materials. Interestingly, even though the reducing sugars in the finished food products were about the same, the acrylamide level in the low reducing sugar finished food products was substantially lower, about one-half that found in the higher reducing sugar raw potato. Without being limited by theory, there are several possible explanations for this. The amount of free asparagine may have been reduced, or the reducing sugars that appear to form during processing may not be reactive for acrylamide formation, or the mobility of the reactants may have been limited as a result of the heating step.

As used herein, the term “food” refers to food ingredients such as starch based food ingredients, including but not limited to corn, wheat, barley, rye, potato, sweet potato, rice, cassava, oats, millet, pumpkin, sorghum and other whole grains, and mixtures thereof that are used to make fabricated food products, as well as food such as whole potatoes or potato slices that have substantially intact cellular structure.

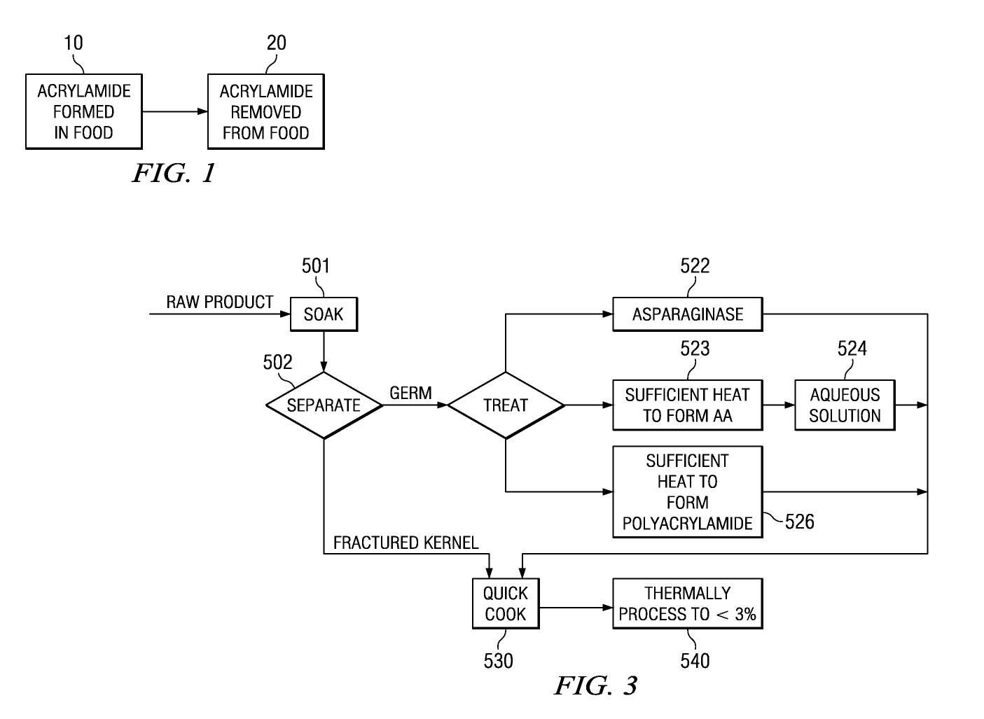

FIG. 1 is a general flow chart depiction of a method for making a low acrylamide food product. As shown in FIG. 1, in one embodiment of the present invention, acrylamide is first formed 10 in the food or food ingredient. Acrylamide can be formed 10 in foods when asparagine and reducing sugars are heated above 120° C. Such heat can be applied to the food ingredient by methods including, but not limited to, roasting, toasting, dry blanching, pressure cooking at a pressure greater than about 15 psig and preferably greater than about 20 psig, frying, par-frying, microwaving, and baking. Any suitable heating method can be used to heat the food or food ingredient to a food temperature of greater than about 120° C.

Acrylamide formed in the food ingredient can then be removed 20 from the food or food ingredient by various methods. In one embodiment, the acrylamide is removed 20 from the food ingredient with the application of sufficient heat to polymerize the acrylamide to form an acrylamide reaction product such as biologically benign polyacrylamide by heating the food or food ingredient above the polymerization temperature of acrylamide. In one embodiment, the acrylamide is removed 20 by reducing the pressure to vaporize the acrylamide. In one embodiment, the acrylamide is leached into an aqueous solution to remove 20 the acrylamide from the food product.

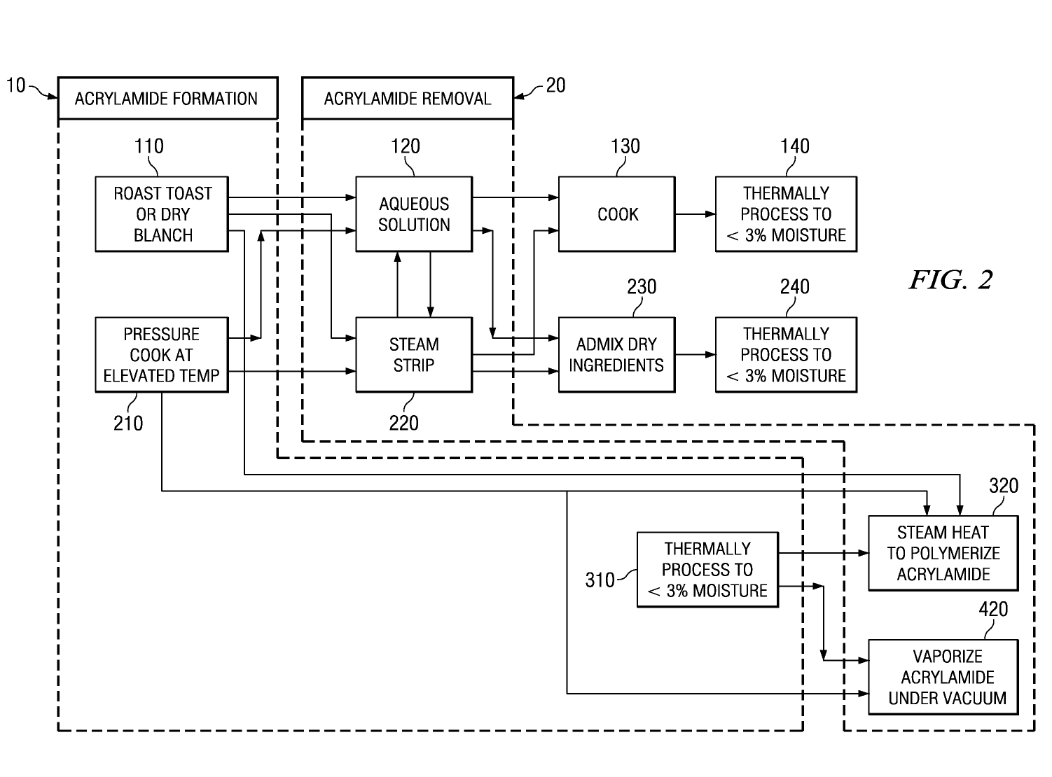

FIG. 2 is a flow chart depicting various embodiments of the present invention. As shown in FIG. 2, in one embodiment, a food ingredient can be roasted, toasted or dry blanched 110 at a food temperature above about 120° C. and more preferably above about 132° C. (270° F.), thereby causing the formation 10 of acrylamide and/or acrylamide reaction products. For example, in one embodiment, the food ingredient can be toasted at 146° C. (295° F.) for about 15 minutes to produce acrylamide. In one embodiment, the food ingredient can be roasted at 185° C. (365° F.) for about 5 to 10 minutes to produce acrylamide reaction products such as polyacrylamide. Such time and temperature relationships are provided for purposes of illustration and not limitation. As used herein, the term acrylamide reaction product refers to products including, but not limited to, polyacrylamide. Polyacrylamide is biologically benign and not recognized to have any adverse health affects. Polyacrylamide can be made from acrylamide by heating acrylamide above a temperature of about 144 C. in the presence of salt, and above a temperature of about 156° C. without the presence of salt and preferably above a temperature of 180° C. with or without salt. For purposes of simplicity, the term polyacrylamide will be used interchangeably with the term acrylamide reaction product; however, the term polyacrylamide when used in this specification expressly includes other acrylamide reaction products.

The food or food ingredient such as corn can then be placed into an aqueous solution 120 or steam stripped 220, for example, in a steam tunnel. In one embodiment, the acrylamide and/or polyacrylamide can leach out of the food or food ingredient and into the aqueous solution 120 thereby removing 20 any soluble acrylamide. In one embodiment, the aqueous solution 120 is maintained at a blanching temperature. As used herein, a blanching temperature occurs when the aqueous temperature comprises a temperature between about 60° C. (130° F.) to about 100° C. (212° F.). In one embodiment, the aqueous solution 120 is maintained at a steeping temperature. As used herein, a steeping temperature is defined as the temperature between ambient and about 60° C. (130° F.). In one embodiment, the aqueous solution is held at reduced pressure (e.g., less than about 20 torr) at an elevated temperature (100° C. to 120° C.) to permit the acrylamide to boil out of the food and partition between the steeping solution and the headspace.

In one embodiment, a suitable compound such as calcium hydroxide, calcium chloride, sodium chloride, or sodium hydroxide can be used to dissolve the acrylamide and/or to complex with any remaining free asparagine and/or reducing sugars, such that the acrylamide, asparagine and/or reducing sugars are unavailable to react within the food or food ingredient prior to additional thermal processing.

In one embodiment, the acrylamide is removed 20 by use of a steam strip 220 under atmospheric or reduced pressure conditions, either alone or in combination with the aqueous solution 120. In one embodiment, steam stripping 220 can occur with steam having a steam temperature of less than about 120° C. at ambient pressure. In one embodiment steam stripping 220 can occur at an absolute pressure of between about 0 torr and about 760 torr and more preferably between about 0 torr and about 20 torr to remove the acrylamide formed in the treated food. Use of reduced pressure can cause acrylamide to boil at temperatures below about 120° C. The steam can advantageously carry the acrylamide vapor away from the food or food ingredient. Maintaining the steam stripping temperature below about 120° C. prevents additional acrylamide formation.

In one embodiment, the roasted, toasted, or dry blanched food ingredient including, but not limited to wheat, rice, sorghum, and other whole grains, is fractionated to separate the starch from the germ thereby permitting the germ and starch fractions to be treated differently. The starch fraction is more sensitive to heat and moisture in terms of damaging the starch and having a negative impact on product quality and the germ is much more robust to thermal treatment. In food ingredients having a germ and pericarp, the acrylamide appears to develop in the region between the germ and pericarp. Therefore by fractionating the food, such as a corn kernel, the acrylamide developed during thermal treatment can be exposed to an aqueous 120 or steam 220 environment where the acrylamide can be readily dissolved and extracted. The germ fraction can then be treated with steam 220 at near saturated steam temperatures in a steam tunnel or alternatively washed with an aqueous solution 120.

In one embodiment, the food ingredient such as corn is cooked 130 in a steam tunnel to limit the time and temperature exposure of the food ingredient. Unlike prior art nixtamalization processes, one embodiment of the present invention reverses the steeping step and the cooking step 130 such that the steeping step for corn that is soaked in an aqueous solution 120 at ambient temperature occurs prior to the cooking step 130. In such embodiment, one must be careful not to over gelatinize the corn in the cooking step 130, whether occurring by the use of steam or hot water, because if the corn becomes too gelatinized, it will become very sticky and unsheetable. Consequently, in one embodiment, the food ingredient such as corn is cooked 130 at a temperature below its gelatinization temperature, which for corn is a temperature of less than about 71° C. (160° F.) and is cooked 130 with less water than is used in a traditional nixtamalization process. In one embodiment, at least about 5 pounds and, more preferably, about 6 pounds of corn (pre-soak weight) are used per gallon of cook water.

Following the cook, the cooked food ingredient such as corn can be sent to a hydrosieve to separate the corn and water. The corn can then be washed, milled into a dough, sheeted, optionally toasted in a toast oven prior to being thermally processed 140 at a temperature of greater than about 120° C. to less than 3% moisture. As used herein, the term “thermally processed” can include, but is not limited to thermal processing that occurs during baking, frying, infrared heating, and microwave heating. While this prophetic example was shown with the use of corn, those having ordinary skill in the art will recognize that such process is conducive to other food ingredients, including but not limited to, rice and whole grains such as sorghum, wheat, oats, and barley.

In one embodiment, an uncooked, blanched, or raw food ingredient is pressure cooked 210 at temperatures sufficient to react available asparagine and reducing sugars to form acrylamide and/or polyacrylamide. Consequently, in one embodiment, the raw food ingredient is pressure cooked 210 in solution at a pressure of greater than about 15 psig and preferably at a pressure greater than 20 psig to ensure that the raw food ingredient is pressure cooked 210 at a food ingredient temperature of at least about 120° C. and preferably greater than about 125° C. to permit the formation of acrylamide during the cooking process.

In one embodiment, once the desired cooking time has elapsed, a controlled reduction in pressure over time can be used to “explode” the cooked food ingredient, thereby increasing the degree of contact between the aqueous solution 120 and the internal structure of the raw food ingredient. In one embodiment, a slower reduction in pressure can occur to preserve the integrity of the cellular structure of the cooked food. Those having ordinary skill in the art, armed with this disclosure, will be able to determine the rate of the pressure reduction based upon a myriad of factors including, but not limited to the type of food ingredient that has been cooked and the degree to which that food ingredient has been cooked.

As the cooked food ingredient and excess cook water are pumped to a water separation device, additional turbulence and mixing of the food ingredient and excess water can occur permitting the water soluble chemical compounds such as acrylamide and asparagine to be leached into the excess water. Thus, when excess water is removed from the cooked food ingredient, the water soluble acrylamide is also removed. The excess water fraction can be optionally processed through a hydrocyclone or other suitable device to remove or further react the acrylamide and other dissolved compounds such that they can be effectively removed from the water so that the water can be recycled and used in another batch of cooking.

In one embodiment, because acrylamide is highly soluble, the water can be recycled for multiple cycles with some make up water added to keep the concentration below saturation. In one embodiment, reverse osmosis or membrane separation, alone or in combination with one or more hydrocyclones, can be used to treat all or a portion of the excess water fraction to remove the acrylamide. Make up water can be used as necessary and can be fresh water or water from the treated stream that had acrylamide removed. By selectively filtering the water with the correct membranes or other filters it is possible to allow other compounds that may be desirable (like dissolved fractions of pericarp) to reach saturation thereby eliminating their solvent effect and maximizing the presence of water soluble compounds from the grains in the final product. In one embodiment, the acrylamide from the excess water fraction can be polymerized and optionally then filtered. In one embodiment, the pressure can be reduced to an absolute pressure of between about 0 torr and about 20 torr while the temperature of the excess water is sufficient to permit the acrylamide to boil off.

In one embodiment, the pressure cooked 210 food ingredient is steam stripped 220 under atmospheric or reduced pressure conditions, either alone or in combination with an aqueous solution 120. In one embodiment, steam stripping 220 can occur with steam having a steam temperature of less than about 120° C. In one embodiment, the steam stripping 220 can occur at an absolute pressure of between about 0 torr and 760 torr. The treated food can then be admixed with other dough ingredients and water 230 and the mixture can be formed into dough and thermally processed 240 to a moisture content of less than 3% by weight. While the above cooking process is discussed generally with regard to a food ingredient, those having ordinary skill in the art, armed with the present disclosure will recognize that such process can be advantageously applied to food ingredients including, but not limited to whole potatoes, including sweet potatoes, potato slices, potato flakes, potato granules, pumpkin, cassava, and whole grains, including, but not limited to rice, wheat, barley, sorghum, and oats. For example, dehydrated potato products such as potato flakes are made from potatoes that have been cooked to permit them to be mashed. In one embodiment, such cooking can comprise pressure cooking 210. If the cooked potatoes are mashed and kept hot (e.g. above about 71° C.) the mashed potatoes could be exposed to vacuum. This would dry the mash and remove some of the acrylamide. Since the vapor pressure of acrylamide is less than the vapor pressure of water, the dried mashed potatoes should have an acrylamide reduction. It's further believed that additional acrylamide reduction can occur if the dried potatoes are rehydrated and the vacuum heating/dehydration is repeated.

In one embodiment, acrylamide is removed from a thermally processed food product having a moisture content of less than 3% by weight. A thermally processed food product can be fabricated food products such as crackers, tortilla chips or potato chips or can be raw food ingredients such as potato slices that have been thermally processed to moisture contents of less than 3% by weight. In one embodiment, thermal processing 310 can comprise frying, baking, or any other suitable means.

Acrylamide can be removed from a thermally processed food product by polymerizing the acrylamide 320 to form acrylamide reaction products. As mentioned above, acrylamide polymerizes 320 upon reaching temperatures greater than about 156° C., and at temperatures of greater than about 144° C. in the presence of salt. Unfortunately, applying such temperatures to food products that have already been thermally processed to moisture contents of below about 3% by weight can negatively impact organoleptical properties because exposure to such temperatures can cause low moisture food products to scorch, thereby providing an unacceptable and undesirable food product. Consequently, one embodiment of the present invention is directed towards exposing a thermally processed food product such as a fried or baked potato chip, tortilla chip or cracker to temperatures of above about 144° C. more preferably above about 156° C. and in one embodiment above about 180° C. to polymerize the acrylamide without scorching the food product by maintaining the moisture content level within the thermally processed food product.

Those having ordinary skill in the art, armed with this disclosure, will be able to calculate with the use of steam tables or on-line steam table calculators, such as one available at http://www.steamtablesonline.com/steam97web.aspx steam properties for various conditions. For example, steam at a pressure of at least about 43.7 psig is required to reach polyacrylamide polymerization temperature (in the presence of salt) of 144° C. or 291° F. Similarly, steam at a pressure of at least about 66.2 psig is required to reach polyacrylamide polymerization temperature of 156° C. or 312.8° F. Additional pressure steam can be used to provide a temperature above the desired minimum temperature required to develop the desired polymerization. However, in one embodiment, the temperature within the chamber is preferably less than the smoke point of oil in the case of a thermally processed food product that has been fried and is therefore less than about 232° C. Consequently, in one embodiment, the pressure within the chamber is between about 65 psig and about 75 psig.

One way to preserve the moisture content within the thermally processed food while raising the temperature of the acrylamide above the polymerization temperature is to place the food product into an atmosphere containing sufficient moisture such that the moisture inside the food product is in equilibrium with the moisture in the atmosphere surrounding the food product. When stated differently, there should be sufficient moisture provided by the steam within a chamber to provide moist air, such that at temperatures greater than the polymerization temperature of acrylamide, the moisture in the thermally processed food product or at the surface of the thermally processed food product is in equilibrium with the steam atmosphere. To achieve this, the product and the atmosphere have to be at the same temperature and the atmosphere relative humidity has to equal the water activity of the food at that temperature. For the case of a pure steam atmosphere, the partial pressure of water in the food (which is the food water activity times the vapor pressure of water) must equal the steam pressure.

In view of the above, one skilled in the art will understand that by maintaining the pressure, relative humidity and temperature of the atmosphere within the chamber, so the thermally processed food product neither gains nor loses moisture while it is being heated to promote the polymerization reaction of the acrylamide. Consequently, the invention in one embodiment provides a way to reduce the level of acrylamide in a thermally processed food product. In one embodiment, the food or food ingredient is left at the elevated temperature of between about 144° C. and about 232° C. until the acrylamide precursors have reacted to completion. Those having ordinary skill in the art armed with this disclosure will be able to ascertain the necessary time and temperature based upon experimentation with the specific food ingredient at issue.

In one embodiment, a steam superheater can be used to reduce the relative amount of water vapor in the saturated steam. The steam pressure used is merely to achieve the result that the moisture in the product is in equilibrium with the moisture in the atmosphere—e.g., the product does not dehydrate or rehydrate. While rehydration is not an issue in terms of acrylamide mitigation as the acrylamide is transformed by the process to polyacrylamide, the product can be dehydrated to desired finished product moistures without creating significant additional monoacrylamide. Consequently, in one embodiment, the objective is to treat a finished product at, or near, the food product's equilibrium moisture content. When attempting to achieve moisture equilibrium between the food product and the chamber atmosphere, the relative humidity of the chamber atmosphere can be initially set to be higher than the water activity of the food product at the chamber temperature. Such embodiment may cause a slight moisture gain in the finished product which may require one to reduce finished product moisture slightly by processing in an additional drying step after the polymerization reaction heating has been completed, but should also minimize the possible risk of scorching.

Those having ordinary skill in the art will recognize that various embodiments of the present invention can be combined. For example, referring back to FIG. 2, in one embodiment a food ingredient is roasted, toasted or dry blanched 110 and then routed directly to a steam chamber to polymerize 320 the acrylamide formed in the heating step 110 to form polyacrylamide. Such embodiment can be used for a food ingredient such as corn, wheat, or potatoes prior to making corn masa, wheat dough, potato flour, or potato flakes.

In one embodiment, a food product is thermally processed to less than 3% moisture 310 and is then held at a temperature greater than about 130° C. while under vacuum 420 at a pressure of less than about 2 kPa (15 torr) for at least one minute to permit vaporization of the acrylamide to occur.

FIG. 3 is a flow chart depicting an alternative embodiment of the present invention. FIG. 3 depicts a method for making a corn-based product from degermed corn. First, raw corn is soaked 501 in fresh water, or an aqueous lime solution to steep the corn to a moisture content of between about 20% and about 40%. Although an aqueous lime solution is disclosed, any other suitable alkalyzer in sufficient quantity to maintain the steep water at or above a pH of 10 can be used. In one embodiment, the corn is steeped in water having a temperature less than its gelatinization temperature of 71° C. (160° F.) for several hours to hydrate the corn for moisture content of less than about 40% moisture. The hydrated corn (also called steeped corn) can then be squeezed by passing the kernels through a nip to fracture the kernels and push the intact germ from the fractured kernel. The germ and fractured kernels can be separated 502 by screening.

The germ has a relatively higher content of acrylamide precursors than the fractured kernel. For example, tests of dried whole kernel corn have revealed a mean asparagine concentration of 220 ppm with a range of 100 ppm to 380 ppm. Tests of dried whole kernel corn has revealed a total mean reducing sugar concentration of 0.36% by weight (0. 19% glucose and 0. 16% fructose) with a range of between 0.20% to 0.93% by weight. By comparison, degermed corn meal had a mean asparagine level of 54 ppm with a range of 45 to 60 ppm. Degermed corn meal revealed a reducing sugar concentration of 0.39% by weight with a range of 0.36% to about 0.41% by weight. Thus, the level of asparagine in degermed corn meal is roughly one-quarter the level in dried corn kernels. Consequently in one embodiment, the germ is substantially removed from the process and is not used to make the thermally processed food product.

In one embodiment, the germ is treated to minimize the amount of acrylamide that is formed during the later thermal processing step 540. In one embodiment, the germ is treated with asparaginase 522 to minimize the amount of asparagine available to react with reducing sugar and form acrylamide. In one embodiment, the germ is treated with sufficient heat to produce acrylamide 523. Consequently, in one embodiment, the germ is treated with sufficient heat 523 to cause the germ to reach a germ temperature above the acrylamide formation temperature of 120° C. In one embodiment, the germ is next steeped in an aqueous solution 524 to permit the acrylamide to leach out of the food or food ingredient and into the aqueous solution thereby removing the soluble acrylamide. In one embodiment, the aqueous solution 524 is maintained at a blanching temperature. In one embodiment, the aqueous solution 524 is maintained at a steeping temperature of less than about 60° C. (130° F.).

In one embodiment, the germ is treated with sufficient heat to polymerize the acrylamide to form polyacrylamide 526. In one embodiment, the germ is raised above the polymerization temperature by placing the germ into an atmosphere containing sufficient moisture such that the moisture inside the germ is in equilibrium with the moisture in the atmosphere surrounding the germ. When the germ and atmosphere are in equilibrium, the germ will neither lose nor gain moisture while the germ is being maintained at or above the acrylamide polymerization temperature threshold. By preventing the germ from dehydrating it would be expected that the molecular mobility that the polymerization needs to proceed would be maintained.

To achieve the germ constant moisture content, both the germ and the atmosphere have to be at the same temperature and the atmosphere relative humidity has to equal the water activity of the germ at that temperature. For the case of a pure steam atmosphere, the partial pressure of water in the germ (which is the germ water activity times the vapor pressure of water) must equal the steam pressure.

In view of the above, one skilled in the art will understand that by adjusting the pressure, relative humidity and temperature of the atmosphere within the chamber, the germ moisture content can be kept constant. Consequently, the invention in one embodiment provides a way to reduce the level of acrylamide in a germ. In one embodiment, the food or food ingredient is left at the elevated temperature of between about 144° C. and about 232° C. until the acrylamide precursors have reacted to completion. Those having ordinary skill in the art armed with this disclosure will be able to ascertain the necessary time and temperature based upon experimentation with the specific food ingredient at issue. For example, steam at a pressure of at least about 43.7 psig is required to reach polyacrylamide polymerization temperature (in the presence of salt) of 144° C. or 291° F. Similarly, steam at a pressure of at least about 66.2 psig is required to reach polyacrylamide polymerization temperature of 156° C. or 312.8° F. Higher pressure steam can be used to provide a temperature above the desired minimum temperature required to develop the desired polymerization. Consequently, in one embodiment, the pressure within the chamber is between about 65 psig and about 75 psig.

In one embodiment, the treated germ can then be admixed with the fractured corn kernels and cooked 530 in an aqueous solution. In one embodiment, the germ is not used to make a dough or masa. In either embodiment, the fractured kernels/treated germ admix or the fractured kernels are cooked 530 at a time and temperature sufficient to partially gelatinize the corn. In one embodiment, less water is used in the cooking step 530 than in prior art cooking nixtamalization processes to avoid overgelatinizing the fractured kernels. In one embodiment, at least about 5 pounds of corn (pre-soak weight) are used per gallon of cook water. In one embodiment, the fractured kernels are steam cooked to avoid overgelatinizing the fractured kernels. In one embodiment, the fractured kernels are cooked sufficiently to cook the fractured corn kernels and the treated germ to the desired degree of gelatinization by limiting the water available for absorption during cooking. Further, the parameters of the steam cooking can control the amount of water absorbed by the fractured kernels and treated germ. The parameters are the degree of incoming steam superheat, the amount of incoming hot water for corn hydration, the pressure of the steam cooking, and the temperature of the corn before steam cooking. In one embodiment, any steam not condensed during the cooking can be removed from the cooker and is not returned to the cooker as condensate (i.e. no reflux). In one embodiment, fractured kernels and treated germ can be placed on a conveyer though a chamber where steam and/or hot water is sparged onto the fractured kernels and treated germ. The steam can optionally be superheated before it is sparged with a heat exchanger. In one embodiment, the cooking 530 occurs under subatmospheric pressure and the chamber can have an internal conveyer with an airlock entrance and exit.

Degermed/fractured corn has not been used in the traditional nixtamalization process to make sheeted food products, such as tortilla chips, because the fractured corn is easily overgelatinized in the water cooking step because once the degermed/fractured corn and the water in which it resides reaches the gelatinization temperature (e.g. 65° C. to 71° C.), starch in the degermed/fractured corn will gelatinize completely if enough water is present. Consequently, very little additional heat is required. The degree of gelatinization is also determined by the amount of water present. In a traditional nixtamalization process, whole, non-fractured corn is cooked in excess water. This does not lead to overgletinization because not all of the starch in the whole non-fractured corn is exposed to the hot cooking water during cooking. The intact protective pericarp/hull of whole, non-fractured corn kernels requires cooking water to enter through the vascular system within the kernel. The longer the cook, the more cooking water enters kernels and the greater the degree of gelatinization of the whole, non-fractured corn during cooking. Consequently, the traditional nixtamalization process, unlike the present invention, requires a steeping/soaking step following the cooking step to hydrate but not gelatinize any remaining native corn starch.

The cooked corn constituents can then be sent to a washer to separate the corn in cook water and the corn can then be fed to a corn hopper and routed to the corn washer, which can be used to gently rinse the corn of loosened hulls/pericarp and any lime that was used as part of the cooking solution. From the washer, the dehulled corn can be routed to a drain belt to drain excess water and then can be sent to a corn hopper and routed to a corn mill. In the mill, the corn is ground and routed into a subsequent hopper where it can be pumped via a masa pump to a sheeter where the masa dough is sheeted and the sheet is cut into preforms. In a preferred embodiment, the corn masa is not dehydrated prior to the toasting and/or thermal processing step. The preforms can then be toasted and thermally processed to a moisture content of less than 3% by weight.

### EXAMPLE

Approximately 100 gram size samples of Toasted Corn was prepared by toasting corn kernels in a convection oven set to 150° C. for 10 minutes. For purposes of increasing understanding of the development of acrylamide within the corn kernel, the kernels were broken and the germ fragments were separated from the endosperm fragments. It was not possible to get a 100% separation of the two fractions, but the fractions were substantially separated as indicated by the lab analysis for acrylamide and asparagine. For purposes of comparison, a control corn sample, untreated (e.g., untoasted), of the same raw material was evaluated for asparagine and acrylamide as well. Some of the samples were then evaluated for acrylamide development. The results are shown in Table 1 below.

TABLE 1
Comparative concentration levels of asparagine and acrylamide.

| Sample Description | Asparagine (ppm) | Acrylamide (ppb) |
|---|---|---|
| Control Germ | 1164.2 | <10 |
| Control Endosperm | 143.4 | <10 |
| Toasted Germ | 148.3 | 929.7 |
| Toasted Endosperm | 18.5 | 235.6 |

These test results in Table 1 above reveal that higher levels of asparagine and concomitant levels of acrylamide are formed in the germ. Consequently, separating and treating the germ and/or removing the germ can be expected to lower the levels of acrylamide in thermally processed foods made from such ingredients.

Next, control and toasted samples were cooked and soaked in solution and tested for acrylamide. Specifically, 100 gram sample of corn was admixed into 100 ml of cook water with 1 gm of 99.95% food grade Ca(OH)₂. The solution was preheated to boiling and corn was added to boiling water. Cook time was measured after water temperature recovered to a temperature above 205° F. All corn samples were cooked for 5 minutes at about 205° F. The corn was then quenched to approximately 140° F. by adding a sufficient amount (about 150 grams) of ambient tap water to reach the desired temperature. The corn was soaked at a temperature of about 120° F. and soaked for about 12 hours. The whole corn kernels were then tested for levels of acrylamide. The test results are depicted in Table 2 below.

TABLE 2
Comparative concentration levels of acrylamide.

| Sample | Cooked/Soaked |
|---|---|
| Description | Acrylamide (ppb) |
| Control | <10 |
| Toasted | <10 |

The test results shown in Table 2 demonstrate that acrylamide can be leached by soaking a food ingredient that has had acrylamide formation.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for the reduction of acrylamide formation in thermally processed foods, said method comprising the step of:
a) forming acrylamide in a food by heating said food above an acrylamide formation temperature thereby forming acrylamide; and
b) treating said food to remove said acrylamide from said food.

2. The method of claim 1 wherein said forming acrylamide at step a) occurs by heating said food above 132° C. (270° F.) in a gaseous medium and wherein said treating at step b) comprises soaking said food in an aqueous solution, said aqueous solution having a temperature of less than about 60° C. (140° F.).

3. The method of claim 2 wherein said aqueous solution comprises one or more compounds selected from calcium hydroxide, calcium chloride, and NaCl.

4. The method of claim 2 wherein said food at step a) comprises raw corn.

5. The method of claim 4, wherein a treated food ingredient after step b) is cooked at a temperature of less than about 71° C.

6. The method of claim 5 wherein said cooked food ingredient is sheeted and thermally processed.

7. The method of claim 5 wherein said treated food ingredient is cooked with at least about 5 pounds of said food per gallon of water.

8. The method of claim 1 wherein said forming acrylamide at step a) occurs by heating said food above 120° C. (248° F.) in a gaseous medium and wherein said treating at step b) comprises soaking said food in an aqueous solution having a temperature of greater than about 60° C. (140° F.).

9. The method of claim 8 wherein said food at step a) comprises wheat.

10. The method of claim 1 wherein said food comprises one or more food ingredients selected from raw corn, raw potato, and raw wheat.

11. The method of claim 1 wherein said forming at step a) occurs by heating said food above 120° C. (248° F.) in a liquid medium and wherein said treating at step b) comprises heating said acrylamide food in an aqueous solution having a temperature of less than about 60° C. (140° F.).

12. The method of claim 1 wherein said treating at step b) comprises using steam to strip said acrylamide from said food.

13. The method of claim 1 further comprising step c) thermally processing said food above a temperature of about 120° C. to a moisture content of less than about 3% by weight.

14. The method of claim 1 wherein said forming acrylamide at step a) occurs by heating said food above 120° C. (248° F.) to a moisture content of less than about 3% by weight to make a thermally processed food and wherein said treating at step b) occurs by forming acrylamide reaction products in said thermally processed food.

15. The method of claim 14 wherein said polymerizing occurs in a steam atmosphere at a food temperature of between about 144° C. and about 232° C.

16. The method of claim 15 wherein said steam atmosphere is in equilibrium with a moisture level in said thermally processed food.

17. The method of claim 14 wherein said food is soaked in an aqueous solution.

18. The method of claim 17 further comprising the step of admixing other food ingredients with said food.

19. The method of claim 14 wherein said food consists essentially of a germ.

20. The method of claim 1 wherein said food consists essentially of a germ.

21. The method of claim 1 wherein said treating occurs by vacuum, wherein sufficient vacuum is applied such that said acrylamide vaporizes.

22. The method of claim 1 wherein said forming acrylamide at step a) occurs by pressure cooking said food product and wherein said treating at step b) comprises soaking said food product in an aqueous solution.

23. The method of claim 1 wherein said forming acrylamide at step a) occurs by heating said food above 132° C. (270° F.) in an air medium and wherein said treating at step b) occurs by polymerizing said acrylamide to form a polyacrylamide in a steam atmosphere at a food temperature of between about 144° C. and about 232° C.

24. A method for the reduction of acrylamide formation in thermally processed foods, said method comprising the step of:
a) providing a food ingredient having a germ; and
b) removing said germ from said food ingredient thereby creating a degermed food ingredient;
c) cooking said degermed food ingredient;
d) milling said degermed food ingredient to make a dough;
e) sheeting and cutting said dough into a plurality of pre-forms; and
f) thermally processing said pre-forms.

25. The method of claim 24 wherein said germ is treated to remove acrylamide or render an acrylamide pre-cursor unavailable to form acrylamide thereby making a treated germ.

26. The method of claim 25 wherein said germ is treated by heating said food above 120° C. (248° F.) in a gaseous medium and wherein said treating at step b) comprises soaking said food in an aqueous solution having a temperature of greater than about 60° C. (140° F.).

27. The method of claim 25 wherein said germ is treated by heating further comprising the step of treating said germ by forming acrylamide reaction products in said germ to make a treated germ and admixing said treated germ with said degermed food ingredient.

28. The method of claim 25 wherein said treated germ is admixed with said degermed food ingredient at some point prior to step e).
